(19) United States
(12) Patent Application Publication
(10) Pub. No.: US 2008/0215437 A1
(43) Pub. Date: Sep. 4, 2008

(54) System, apparatus and method for advertising using a data storage device

(76) Inventors: Jimmy Levy, Moshav Yarkona (IL); Nir Michalowitz, Caesaria (IL); Ronen Hod, Shoham (IL); Itamar Gilad, Kiryat Haim (IL); Sivan Perry Tafla, Petach-Tikva (IL); Yechiam Yemini, Fort Lee, NJ (US); Sara Bitan-Erlich, Hadar-Am (IL)

Correspondence Address: Pearl Cohen Zedek Latzer, LLP, 1500 Broadway, 12th Floor, New York, NY, 10036, US

(21) Appl. No.: 12/010,760

(22) Filed: Jan. 29, 2008

Related U.S. Application Data
(60) Provisional application No. 60/898,107, filed on Jan. 30, 2007.

(51) Int. Cl. G06Q 30/00

(52) U.S. Cl. 705/14

(57) ABSTRACT

A system, method, and apparatus for downloading advertisements, storing advertisements on a storage device, selecting advertisements for presentation, and presenting selected advertisements. In some embodiments of the invention, advertisements may be dynamically associated and presented in coordination with content according to predefined parameters, stored information, and other criteria. Advertisement credits may be allocated in exchange for advertisement consumption. Advertisements and other information may be exchanged with remote servers. Other embodiments are described and claimed.

### CROSS-REFERENCE TO RELATED APPLICATIONS

The present application claims benefit from an earlier filed provisional patent application, U.S. Application Ser. No. 60/898,107, filed Jan. 30, 2007, and entitled “Personal storage advertising,” the entire contents of which are incorporated herein by reference.

### FIELD OF THE INVENTION

This invention relates to the field of Content Distribution Networks (CDN) and, in particular, to methods and systems for targeted advertising and e-shopping.

### BACKGROUND OF THE INVENTION

Traditional electronic advertising, e.g., over television, radio, or the Internet, and distribution of advertisement-sponsored content have many advantages associated with their online and/or broadcasting nature, for example, the ability to instantaneously or rapidly reach a global audience. Current methods and systems for distribution of advertisement-sponsored electronic content typically include the advertiser launching a campaign, and paying a content distributor, e.g., an Internet site, or radio or TV channel, to present the advertisement to its consumers.

Advertisements in current digital media (e.g., TV, radio, Internet) may be coupled with, or bound to, content. Some types of content (e.g. audio, video) arrive with dedicated advertisements place holders, also known as spots. Spots may be either time slots (in audio or video), an area in a page/screen (in video or document), or a combination of both. Spots in the content may be replaced by advertisements prior to presentation of content to consumers. Content may be accompanied by meta-data, which may contain pointers or references to the available spots.

Advertisements provided by current digital media are typically bound to, or associated with specific content, for example, to content provided by an Internet site, or a television or radio channel. Furthermore, traditional electronic content and/or advertisements delivery methods provide limited capabilities for features such as targeting specific audiences, user subscriptions for specific contents, rating of content by consumers, or monitoring, tracking and/or recording consumption of content and/or advertisements.

### SUMMARY OF EMBODIMENTS OF THE INVENTION

According to embodiments of the invention, a local or personal storage and presentation system may present different challenges and advantages as an electronic publishing medium than traditional media (e.g., radio, television, or Internet), and thus may require new mechanisms to enable advertisement-sponsored content delivery to users. Aspects of such mechanisms are described below.

According to embodiments of the invention, a local or personal storage and presentation system may enable users to download and consume large volumes of high quality content such as multimedia, music, games and the like. Such content may often be consumed off-line, namely, without requiring that the consumer be connected to the network over which the content is delivered. Unlike fixed storage media, such as CDs and/or DVDs, where both content and advertising (e.g., previews) are pre-loaded or statically bound, according to embodiments of the invention, local or personal storage and presentation devices may be replenished with new content and/or advertisements over a network connection when such connection may be available. In accordance with embodiments of the present invention, content and advertisements may be manipulated or served to target personal interests of their consumers.

According to traditional advertising systems and methods, advertisements may miss their target audiences. For example, an advertiser may pay for binding an advertisement to particular content; however, the advertisement may never be viewed, for example, if the content to which the advertisements are bound was never actually consumed. According to embodiments of the present invention, both content and advertisements may be pre-loaded into a personal storage and presentation system prior to being consumed. Therefore, in some embodiments of the present invention, advertisers and/or content providers may be provided with means for tracking presentation of advertisements to consumers. Some embodiments of the present invention may therefore provide a business infrastructure and/or a business method for charging an advertiser for advertisements and/or content that have actually been consumed. Additionally, some embodiments of the present invention may enable advertisements that are not associated with, or otherwise bound to, any specific content, but rather selected based on other criteria, for example, a user profile, etc. Optionally, in some embodiments of the invention, a user may be granted a consumer credit, which may be used for shopping, or e-shopping, or for obtaining certain content. Alternately, the user may be permitted to pay for content being consumed without advertisements.

According to embodiments of the present invention, insofar as users may consume pre-loaded content and/or advertisements off-line, the logic of binding advertisements to content may be performed locally, i.e., at the local or personal storage and presentation system level, rather than at a centralized network server or head end system. As discussed below, this may result in benefits of advertisement personalization using private data without compromising consumer privacy.

Embodiments of the present invention may comprise different aspects of advertisement-sponsored personal storage publishing including: pre-loading advertisements to personal storage and presentation, targeting specific interests of users, and organizing rules for binding content and advertisements; binding advertisements to content while the content is provided from the local or personal storage and presentation; and a marketplace for content providers and advertisers to bid, pay, compete, or otherwise obtain access to consumer local or personal storage and presentation devices.

In accordance with other aspects of the present invention, there may be provided a system and method of doing business comprising use of advertisement-credits for playing content from local or personal storage. Advertisement-credits may enable a consumer to pay for products, e.g., digital content or other products, by viewing or otherwise consuming advertisements. Advertisement-credits may be accumulated, stored, maintained, exported, swapped, bartered, traded, and/or otherwise used for paying for products provided in association with consumer's local or personal storage.

While the advantages of the present system and method are many, below are enumerated some but not necessarily all possible advantages of a system according to the present invention. It will be further understood that some advantages may be absent from any particular embodiment of the present invention based on its configuration.

Among advantages of some exemplary embodiments of the present invention are: enabling targeting both content and advertisements at specific interests of users, including interest in content provided by prior art (e.g. TV programs, etc.); enabling detailed tracking of consumption of both content and advertisements and respective reporting without privacy violation, as personal information may be kept under user's custody; and enabling bookmarking, storage and reuse of advertisements.

Furthermore, some embodiments of the present invention may allow end users to: consume advertisements from storage; optionally bind pre-stored advertisements to content; update advertisements periodically by downloading updated advertisements to the local storage and presentation system; benefit from a dynamically targeted selection of advertisements from storage according to criteria including: geographic location, date, user profile, including dynamic content tracking information, etc.; actively control or otherwise dictate advertisement format, timing etc., for example, interactive advertisement consumption, including bookmarking of advertisements for later use, invoking advertisement from another advertisement etc.; and accumulate and use advertisement-credits to pay for content, or export the credits to another system, e.g., shopping or e-shopping.

Some embodiments of the present invention may allow advertiser to: launch a campaign to users from a local or personal storage and presentation device; enforce a campaign policy where a policy may be defined by an advertiser, by a distributor, or a publisher. A policy may be furthered defined for a specific consumer. According to embodiments of the invention, a policy may be stored locally by embodiments of the invention and/or received from a remote computer. Embodiments of the present invention may enable an optimization of a campaign's effectiveness by using off-line dynamic targeting based on parameters such as, but not limited to, content, geographic location, date, and/or user profile, including content and advertisements personal tracking data, and time constraints. For example, advertisements may be scheduled for consumption according to an expiration time or date, for example, an expiration of a campaign with which the advertisements are associated; and individually track advertisement consumption, and use such information to improve stored and consumed advertisement selection.

Some embodiments of the invention may enable a content owner to: enforce content and advertisement binding online and/or offline; and promote and advertise content effectively by using trailers, and/or allowing user interaction.

In accordance with other aspects of the present invention, there may be provided an advertisement consumption system comprising a personal storage advertising sub-system, and a content consumption and payment sub-system.

A personal storage advertising sub-system may perform the following: pre-fetch advertisements to local storage, according to, for example, user personal profile, tracking data, and/or policy, wherein in some embodiments, policy may be dictated by the end user, and/or the advertiser; select advertisements for consumption, according to guidelines, which may optionally be entered by the user, and possibly hand them to a content consumption and payment system; track advertisements consumption, store tracking data in a user's personal storage, and optionally report to a central and/or remote server; and synchronize with centralized or distributed network based tracking and control systems.

The content consumption and payment sub-system may include several content and advertisements consumption modules, and may allow a user to consume different types and formats of advertisements and content. The content consumption and payment sub-system may perform the following: enforce content viewing policy (including payment policy); enforce advertisements viewing or consumption policy (e.g. implement a campaign); enable bookmarking advertisements, and navigation between advertisements and content; collect advertisement-credits; and manage advertisement-credits, for example, enable payment for content consumption by advertisement-credits.

In accordance with other aspects of the present invention, there may be provided a method of flexible payment for content consumption.

In accordance with other aspects of the present invention, there are provided a local advertisement server configured to select, play and track advertisements from a personal storage and presentation system.

As discussed above, targeted advertisement may be deployed today both in broadcasting networks (TV, radio), and in the Internet. It works well in the Web, where customer behavioral analysis may be used to produce targeted advertisement, which makes it more effective, hence easier to sell, and more profitable for the advertiser. This model may be implemented by several advertisement platforms that store the advertisements, the advertisement policy and the tracking data centrally. In this model the advertisements are either both pre-allocated to the content and tracked online, or allocated and tracked online, i.e. whenever the content consumption system detects an empty spot, it sends all the relevant data to central server which may allocate an advertisement from a specific campaign to this spot.

When implementing targeted advertising using local or personal storage and presentation as the advertising medium, in accordance with embodiments of the present invention, new challenges and advantages may arise. According to the present invention, content and/or advertisements may be played from storage. This presents several constraints to be overcome.

For example, content in storage might be long-lived, while advertisements may be short-lived, near-term, or otherwise time-dependent. Thus, advertising campaigns that existed when the content was downloaded may no longer be relevant when the content is consumed. According to embodiments of the present invention, timely advertisements may be bound to content being played or scheduled to be played regardless of when the content or advertisements were downloaded, but rather, based at least in part on selection criteria, for example, as provided by the advertiser. Embodiments of the invention may enable a decoupling of advertisements consumption from content consumption. Such decoupling may enable embodiments of the invention to manage advertisements consumption and/or campaigns in a manner that may only be loosely coupled to the management of content consumption. For example, an advertisement may be associated with a specific content object, however, a rule, policy and/or campaign may dictate that the advertisement should be consumed no later than a specific date or time. In such case, according to embodiments of the invention, if the content with which the advertisement is not consumed by a specific date or time, the advertisement may be associated with a different content object, for example, a content being currently consumed.

According to embodiments of the invention, the local storage and presentation device may be offline while advertisements are selected. Accordingly, the traditional model in which a remote central behavioral analysis dictates the advertisement policy is impracticable. According to embodiments of the present invention, the logic for selecting advertisements may be local.

In another aspect of some embodiments of the invention, tracking data need not be delivered immediately to a central server, for example, when connection to a server is unavailable or communication with the server is impossible. In such cases, data collected by the system may be delivered to the server when communication with the server is restored.

According to traditional advertising principles, targeted advertisements may be created when the advertisements are selected to be played based on some information about a consumer, rather than played uniformly to every consumer. Targeted advertisement in radio and TV may be based on channel, geographical location of the broadcast, date, and time, i.e., data that must be available during broadcast of the content. In the Internet context, the selection may be based on behavioral analysis, for example, based on the user's browsing history or other user information. These methods are generally limited in that users are reluctant to (knowingly) provide or permit providing private information, and advertisers are unable to access this information, even though it may be available to certain subscription-based content providers.

According to embodiments of the invention, personalization may include modifying content consumed. According to embodiments of the invention, placeholders embedded within content may be populated according to various parameters such as a policy, a campaign and/or a user profile. For example, the brand of products such as beverages, various foods and/or cloths may be modified according to parameters described above. Other examples of such personalization may be a replacement of name tags that may appear in content, for example, a content consumer's name may replace a placeholder in a content, e.g., a name appearing on an envelope or a coffee mug. It will be understood that similar personalization of content may be performed on an advertisement being consumed based on information pertaining to the user.

Accordingly, among the advantages of the system and method embodiments of the present invention may be facilitating local selection of advertisements played from a personal storage advertising sub-system, which may use tracking information relating to consumption of content and/or advertisements, which tracking information may be collected locally. In this manner, personalized tracking information may be protected from exposure to an external server, and personalized advertising may be effected without violating the consumer's privacy.

One result of local selection of advertisements according to embodiments of the present invention may be that the selection logic may use private data about the consumer in order to select data without compromising privacy, for example, by reporting to the advertiser the consumption of an advertisement, but not the identity of any particular consumer or the specific selection criteria based on which the advertisement was played to the consumer.

According to embodiments of the present invention, in which content and advertisements may be provided from a storage and presentation system, enforcement of an advertising policy may be done locally. According to embodiments of the present invention, content may be retrieved and stored independently of advertisements. Accordingly, association of content to advertisements may need to be done by the local system. According to embodiments of the present invention, campaign policies and/or rules may be stored and used by the personal storage and presentation system. According to embodiments of the present invention, policies and/or rules may be used as input to an advertisement selection and retrieval module. It will be recognized that the selection and retrieval module may also schedule and/or coordinate presentation of the selected and retrieved advertisement with presentation of content, as described hereinafter. Such campaign policies and/or rules may be used by the personal storage and presentation system in order to associate advertisements with content, for example, a specific advertisement may be required to be provided in association with a specific content item. A campaign may further dictate parameters such as, but not limited to, a time frame for presentation of specific advertisements, a time of day for presentation of specific advertisements, the number of times an advertisement is to be presented, an order according to which a series or group of advertisements is to be presented, etc. According to embodiments of the present invention, such parameters may be considered by the personal storage and presentation system as a basis for scheduling advertisements.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 illustrates a schematic block diagram of an advertisement consumption system in accordance with embodiments of the present invention;

FIG. 2 illustrates a schematic block diagram of an advertising sub-system in accordance with embodiments of the present invention;

FIG. 3 illustrates a schematic flow diagram describing a method for pre-fetching and storing an advertisement in accordance with embodiments of the present invention;

FIG. 4 illustrates a schematic flow diagram describing an advertisement selection method in accordance with embodiments of the present invention;

FIG. 5 illustrates a schematic block diagram of a sub-system for consuming and paying for content in accordance with embodiments of the present invention; and

FIGS. 6 and 7 are schematic flow diagrams illustrating operation of a content consumption and payment driver in accordance with embodiments of the present invention.

### DETAILED DESCRIPTION OF EMBODIMENTS OF THE INVENTION

In the following detailed description, numerous specific details are set forth in order to provide a thorough understanding of the invention. However, it will be understood by those skilled in the art, that the present invention may be practiced without these specific details. In other instances, well-known methods, procedures, components and circuits have not been described in detail so as not to obscure the present invention. In the drawings and descriptions, identical reference numerals indicate those components that are common to different embodiments or configurations.

Unless specifically stated otherwise, as apparent from the following discussions, it may be appreciated that throughout the specification discussions utilizing terms such as “processing”, “computing”, “calculating”, “determining”, or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Unless specifically stated otherwise, the advertisements consumption system in accordance with present invention may be implemented on a platform for personal storage and presentation, wherein the content may be delivered by various methods some of them are known in the art.

The term “content provider” as used in this patent specification should be expansively construed to include any entity or person that owns and/or provides digital content, whether images, video, audio, text, casual gaming, interactive gaming, etc. (e.g. Disney, Virgin, Barnes & Noble, etc).

The term “advertiser” as used in this patent specification should be expansively construed to include any entity or person that owns and/or provides one or more items of digital content, e.g. advertisements, typically but not exclusively promoting a commercial product or service or a non-profit cause. An advertiser may further define and provide an advertising campaign definition. A campaign definition may contain rules, policies and/or other information to accompany one or a plurality of digital content and that may be used for selecting the advertising content for presentation or consumption and/or the timing, context, and circumstances of their presentation. For example, without limiting the scope of the invention, a campaign may define a set of ads for consumption, a time period during which these ads are to be consumed, the order by which the ads are to be consumed, the content types with which the ads are to be associated, etc. It will be understood that an advertisement may include any type of digital content, including any text, still image, video, audio, URL link, or other digital content provided by an advertiser.

The term “content distributor” as used in this patent specification should be expansively construed to include any entity or person that distributes the content directly or indirectly to consumers, for example, an entity or person that owns a content distribution network (“CDN”). A content distributor may distribute content to end users, institutes, or any other content-consuming body. The advertiser may typically distribute advertisements to consumers of content via the content distributor.

The term “user” or “consumer” as used in this patent specification should be expansively construed to include any entity or person that views, plays, enjoys or otherwise consumes the content and the advertisements.

The term “local storage and presentation” or “personal storage and presentation” as used in this patent specification should be expansively construed to include any platform or part thereof facilitating keeping and/or storing certain content in a manner not erasable by loss of power, in full user's custody, including storage and presentation platforms directly and/or locally connected to a computing device, including via a home network, portable storage and presentation platforms, off-line storage and presentation devices and other suitable storage platforms. Such storage may include a hard drive, Flash drive, or other non-volatile memory locally associated with a computing platform, where the computing platform may be a general purpose personal computer possibly connected to a television or monitor, or other presentation device, a set-top box associated with a television, a dedicated audio and/or video media player, etc. Those skilled in the art will readily appreciate that certain teachings of the present invention are not bound by the local or personal storage and presentation and are applicable in a similar manner to other personal storage and presentation platforms not expressly mentioned herein.

In accordance with certain embodiments of the present invention the advertisement consumption system associated with a personal storage and presentation system or device may operate in at least one of several modes. In a first, “semi-online” mode, advertisements may be consumed from local storage, but the advertisement policy and/or selection decision, which dictates which advertisements should be displayed to the consumer, may be made by a central advertisement selection system. The local advertisement server may query the central system, which may calculate, and inform the local advertisement server which advertisements should be retrieved from storage and allocated to which available spots. When consumption of advertisements is successfully completed, tracking information may be sent to the central system.

In a second, “off-line” mode, communication between the local advertisement server and a central advertisement server may be unavailable. Accordingly, policy decisions may be made locally. According to embodiments of the invention, the local advertisement server may have previously downloaded policies, campaign definitions and/or rules and may further use them to enforce advertisement consumption offline. The targeted advertisement decision may be taken locally, based on calculations performed locally, for example, based on cross-channel taste analysis. The local advertisement sever may also collect advertisements tracking information, and upload it to a central tracking server, when a connection becomes available.

In a third, “online” mode, look-ahead may be also possible. In such a mode, the system may know which spot will be available in a short while (e.g., 5 minutes), may ask for an advertisement from a central server, and begin pre-loading the advertisement to storage sufficiently ahead of its scheduled playing time so that the download will be substantially complete by the time the advertisement is to be consumed, thereby avoiding playback delays.

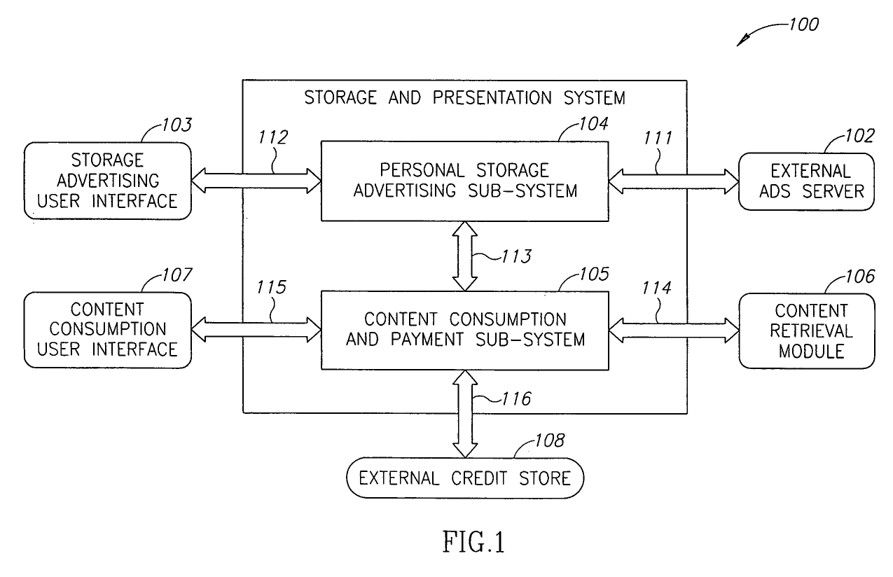

Bearing the above in mind, attention is drawn to FIG. 1, which schematically illustrates a generalized block diagram of storage and presentation system 100, which may comprise at least two sub-systems: a personal storage advertising sub-system 104, and a content consumption and payment sub-system 105.

The personal storage advertising sub-system 104 may pre-fetch advertisements from a remote server, select an advertisement for playing, and/or retrieve advertisements from local storage for consumption. Additionally, the personal storage advertising sub-system 104 may track and report consumption to a remote or external advertisement server 102. Personal storage advertising sub-system 104 may provide selected advertisements through interface 113 to the content consumption and payment sub-system 105, which may display and/or execute them. The advertisement selection, pre-fetch and tracking modules may use content and advertisements tracking data which the content consumption and payment sub-system 105 may provide to them through interface 113.

A user may control the system through the storage advertising user interface 103, and the content consumption user interface 107, which may access the system through external interfaces 112, and 115 respectively.

The system may interface through external interfaces 111, 114 and 116 respectively with other systems. In some embodiments, the system may interface with an external advertisement server 102, which may be a remote server, located at the advertiser's premises. Such remote server may store the advertising content, accompanied by advertising meta-data (e.g. campaign policy), tracking information, configuration control information, etc. In some embodiments, the system may interface with a content retrieval module 106 which may accept requests for specific items from the system 100, and may further return them. Content retrieval module 106 may retrieve content from local or remote storage, using methods which are out of the scope of the invention. In some embodiments, the system may interface with an external credit store 108, which may enable a user to export his advertisement-credits and/or use them in other shopping or e-shopping systems, etc.

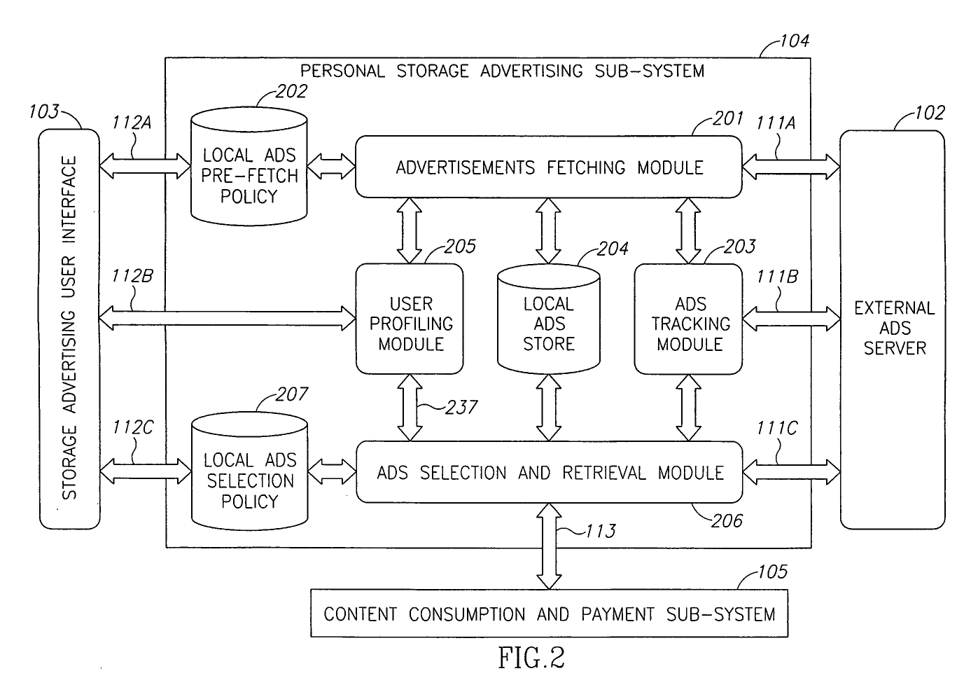

The personal storage advertising sub-system 104 depicted in FIG. 2 may comprise advertisements fetching module 201, advertisement tracking module 203, user profiling module 205, and advertisement selection and retrieval module 206. In addition, personal storage advertising sub-system 104 may contain two policy databases, local advertisements pre-fetching policy 202, and local advertisements selection policy 207 as well as a local advertisements store 204, which contains advertisements, advertisement meta-data, and inventory. An inventory may be, for example, a list or database of all advertisements, and pertinent information relating to the advertisements. An advertisement entry may contain, for example, the advertisements' age, campaign information, tag words or keywords, consumption status, whether viewed, when last viewed, etc.

The sub-system may interface with storage advertising user interface 103 through external interfaces 112ₐ, 112_{b}, and 112_{c}, with external advertisements server 102 through external interfaces 111ₐ, 111_{b} and 111_{c}, and with the local content consumption and payment sub-system 105 through external interface 113.

The advertisement fetching module 201 and the advertisement selection and retrieval module 206 may perform the tasks of personalizing the advertisements, and targeting them to the user, through the use of the user profiling module 205. This module may compute a user profile, possibly based on the inputs including but not limited to: tracking information of content and advertisement consumption, which it may get from the advertisements selection and retrieval module through interface 237; local information derived from the user's machine, for example geographic location, date, time, etc.; and personal taste indicators optionally entered by a user, e.g., areas of interest selected from a list, which may improve the dynamic targeting. Such selections may be performed through external interface 112_{b} and/or the storage advertising user interface 113.

A user profile may be updated regularly. The user profiling module 205 may return it per request to the advertisements fetching module 201 and/or the advertisements selection and retrieval module 206.

One of the tasks of advertisement fetching module 201 may be to retrieve advertisements from a (typically remote) external advertisement server, and store them in the local advertisements store 204. Module 201 may maintain a local advertisements pre-fetch policy 202, which it may construct by combining the external advertisement server 102, advertisement publishing policy, and optionally the user's advertisements pre-fetching guidelines, which may be entered through the storage advertising user interface 103, and/or external interface 112ₐ. The pre-fetch policy 202 may be updated occasionally by the external advertisements server 102 and/or by a user. Depending on the external advertisements server 102 implementation, pre-fetching may be implemented either by pull, by push, or by a combination of both.

In push-based pre-fetching, the client may be passive, e.g., the external advertisement server 102 may retrieve a pre-fetch local policy 202, for example, whenever it may be modified, and may further push the relevant advertisements to the advertisement fetching module 201. In pull-based pre-fetching, the advertisement fetching module 201 may pull advertisements, possibly selected according to the local pre-fetch 202 policy from the external advertisement server 102.

It will be recognized that the invention may be not bound by the configuration of FIGS. 1 and 2, and that equivalent structures and/or functions may be consolidated or divided in other or different manners. For example, in other embodiments of the invention, the sub-systems, modules and/or parts thereof may be placed in single or multiple geographical locations; operative connections between the blocks and within the blocks may be implemented directly or indirectly, including remote connection. The connection may be provided via suitable wire-line, wireless, cable, Internet, Intranet, power, satellite or other networks and/or using any communication standard, system and/or protocol and variants or evolution thereof. The invention may also be practiced in distributed computing environments. Alternatively, the invention may be implemented in a stand-alone form as well as be fully or partly integrated with different devices, including third party equipment.

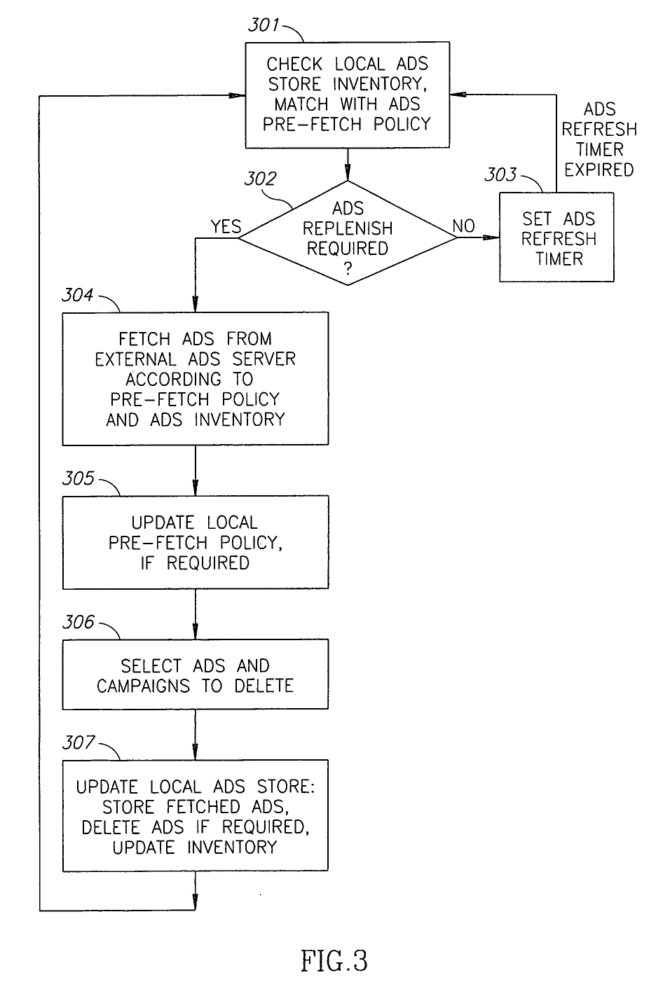

A flow-chart describing a possible advertisements fetching process may be depicted in FIG. 3. Fetched advertisement may contain meta-data, and optional advertising content. If the same advertising content may be used by more than one advertisement, then only a single copy of it may be fetched. Such copy may be pointed to from multiple meta-data. Meta-data may contain campaign data such as but not limited to: which channels/locations should this advertisement be played in, targeting information, expiry date, and exchange related information, e.g., will watching this advertisement grant the user with advertisement-credits, can such credits be used for general purpose, or are they restricted, etc.

The local advertisements store 204 may include an inventory which may contain all the meta-data associated with advertisements in the store, including campaign data. Campaign data may include advertisements display parameters like expiration date, number of exposures, advertisements interrelations data, for example, show advertisement #2 only to users that have seen advertisement #1, or show advertisement #1 and advertisement #2 within 20 minutes time difference. According to embodiments of the invention, and as shown by blocks 301 and 302, the flow may include replenishing of advertisements. For example, advertisements fetching module 201 may periodically, for example, according to a refresh timer expiry, consult the local advertisements store 204 inventory, and the local advertisements pre-fetch policy 202, to determine if a advertisements' replenish may be required. If replenishing is not required, then a refresh timer may be re-initializes as shown by block 303. Otherwise, as indicated by block 304, advertisements may be fetched from the external advertisements server 102, possibly through interface 111ₐ. According to embodiments of the invention, fetching may be executed according to the external server's policy, and the local pre-fetch policy 202. According to embodiments of the invention, during communication with the external advertisements server 102, a check may be performed in order to determine whether a local pre-fetch policy should be updated, and if so, it may be updated as shown by block 305. According to embodiments of the invention and as shown by block 306, the flow may contain checking the local advertisements store 204 inventory. Such check may be performed in order to verify storage space availability. According to parameters such as space limits, advertisements may be deleted from the store at this stage. Deletion of advertisements may be performed according to additional parameters, for example, expiry date of campaigns or ranking of advertisements. According to embodiments of the invention and as shown by block 307, the flow may include updating of local advertisements store 204. Such updating may comprise deleting of selected advertisements, storing of new advertisements. According to embodiments of the invention and as shown, following an update of advertisements store 204 and possibly according to a refresh timer, the flow may repeat the above steps.

According to embodiments of the invention, the advertisements fetching module 201 may act upon asynchronous events from external advertisements server 102. For example, a campaign may be halted or abandon, in such case the local storage may be updated accordingly.

According to embodiments of the invention, advertisements fetching module 201 and advertisements selection and retrieval module 206, may maintain local advertisements selection policy 207. Such maintenance may be performed based on input such as, but not limited to selection guidelines optionally entered by user through the storage advertising user interface 103, and external interface 112_{b}.

According to embodiments of the invention, advertisements selection and retrieval module 206 may control interface 113 with the content consumption and payment sub-system 105. Module 206 may receive requests to allocate advertisements to available spot, select advertisements, retrieve advertisements from the local advertisements store 204, and/or return advertisements to the content consumption and payment sub-system 105. In addition, module 206 may receive from the content consumption and payment sub-system 105 content and advertisements tracking information. Module 206 may hand such information over to the user profiling module 205, and advertisements tracking module 203 respectively.

According to embodiments of the invention, advertisements selection and retrieval module 206 may receive, possibly over interface 113, a request from the content consumption & payment sub-system to allocate advertisements to a set of spots, or a single spot. The request may also include content meta-data that may contain advertisements targeting information. Upon receiving such request, module 206 may use optional processes for advertisements selection.

In a first example, a semi-online process may be used, in which the local advertisement selection policy 207 is used to select a set of available advertisements from the local advertisements store 204 inventory. Information is sent, such as: available spots information (possibly received from the content consumption and payment sub-system 105), partial/full user profile information (possibly extracted from the user profiling module 204), local advertisements selection policy 207, partial advertisements tracking data (possibly obtained from 203), and full or incremental (depending on the external advertisements server implementation) local advertisements store 204 inventory to external advertisements server 102. Server 102 may send back a list of advertisements (from the inventory), which may be allocated to the available spots.

In a second example, an offline process may be used, in which the system consults with the local advertisements selection policy 207, the advertisement tracking module 203, and the user profiling module 204 to determine which advertisements should be allocated to the spots.

The advertisements fetching module 201, may also be able to synchronize with a network based advertisement system. It may handle events such as, but not limited to, rescheduling of advertisements presentation, replacements of advertisements or changes in associations of advertisements with content. An update of a policy rule or a campaign definition may also be an event. For example, an event may be a cancellation of a campaign, in which case, advertisements associated with the campaign may be removed from storage and further actions may be required.

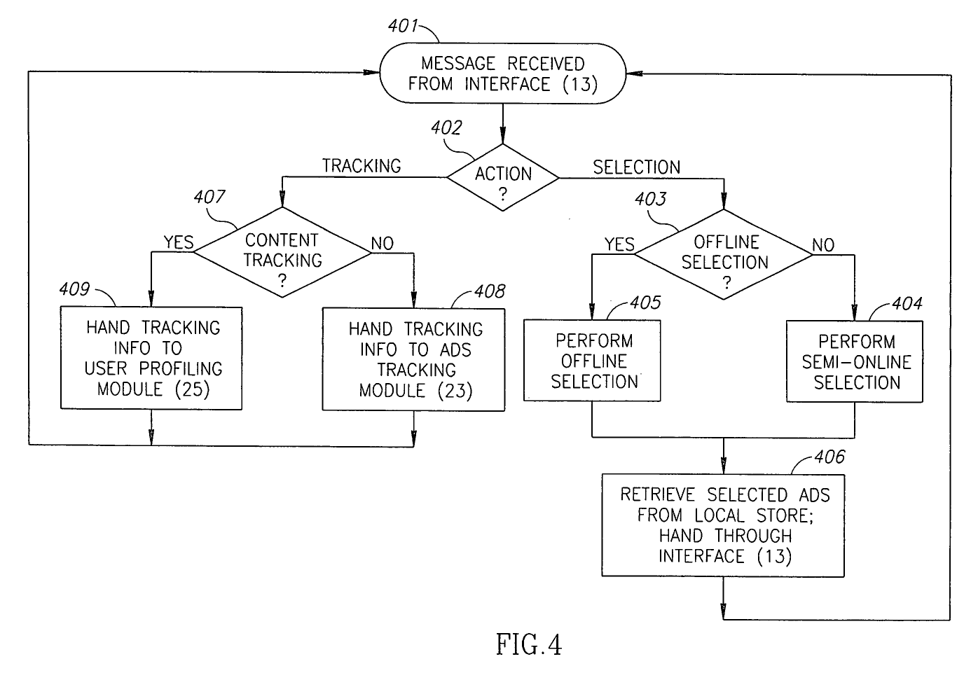

Reference is now made to FIG. 4 which shows an exemplary flow chart describing the operation of advertisements selection and retrieval module 206 according to embodiments of the invention. According to embodiments of the invention and as indicated by block 401, module 206 may receive a message, possibly from the content consumption and payment sub-system 105. According to embodiments of the invention and as indicated by block 402 a received message may be examined. According to embodiments of the invention and as indicated by block 403, if the received message may be a selection and retrieval request, then the flow may be check whether offline or semi-online selection may be desired. Accordingly, as shown by blocks 404 and 405, either semi-online selection process or offline selection process may be performed. According to embodiments of the invention and as indicated by block 406, when the selection process may be concluded, the flow precede to retrieving selected advertisements from local advertisements store 204, and further transfer them to the content consumption and payment sub-system 105, possibly over external interface 113.

According to embodiments of the invention and as indicated by block 407, if the request may be a tracking request, the flow may include determining whether tracking may be requested for content or advertisements. According to embodiments of the invention and as indicated by block 408, if the request may be for advertisements tracking then the flow may proceed by handing the information to the advertisements tracking module 203. Module 203 may store the request for internal use, and may further report relevant parts of it when appropriate to the external advertisements server 102 through external interface 111_{b}.

According to embodiments of the invention and as indicated by block 409, if the request may be a content tracking message, the flow may proceed by handing the content tracking information to the user profiling module, who may store it, possibly to be used in order to calculate an updated user profile.

Advertisements tracking module 203 may receive advertisements tracking information from the advertisements selection and retrieval module 206. Module 203 may store the information, and may further hand it upon request, for example, to the advertisements fetching module 201, or the advertisements selection and retrieval module 206, who may need it for selection of advertisements for pre-fetch and allocation to available spots respectively.

According to embodiments of the invention, advertisements tracking module 203 may also be able to synchronize information with external advertisements server 102. According to embodiments of the invention, it may be desirable that personal tracking information will not be exposed to external advertisements server 102. For example, in order to guarantee user's privacy protection. On the other hand, it may also be desirable that global campaign policy and tracking information will not be exposed to the user. According to embodiments of the invention, it may be a the responsibility of the advertisements tracking module 203 to make sure that the user's privacy may be not violated, and that global tracking information may be not calculated and stored in the local personal storage advertising sub-system 104. According to embodiments of the invention, it may be the responsibility of the external advertisements server 102 to make sure that global campaign policy may be not exposed to the local personal storage advertising sub-system 104.

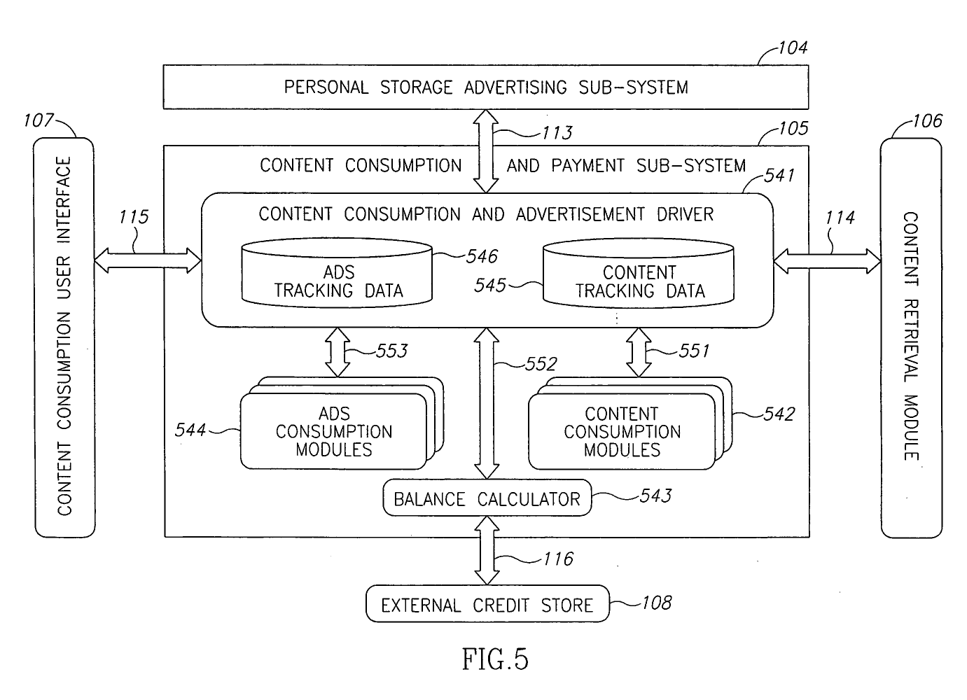

Reference may be made to FIG. 5 showing an exemplary illustration of a content consumption and payment sub-system 105 according to embodiments of the invention. Sub-system 105 may allow and/or require a user to pay for content by consuming or viewing advertisements. The system may allow the user to pay for content consumption with advertisements-credits which may be accumulated by viewing advertisements. In addition, according to embodiments of the invention, a user may export accumulated advertisements credit to an external store, and may further use them to purchase other types of products.

According to embodiments of the invention, content consumption and payment system 105 may comprise several external interfaces. For example, external interface 115 to a content consumption user interface module 107, interface 114 to content retrieval module 106 which may in turn retrieve content from storage, or from network, and interface 116 to an external credit store 108.

Content consumption and payment system 105 may comprise one, some, or all of the following modules.

A balance calculator 543 may calculate and keep track of user's advertisements-credits balance. The balance calculator may also support export of user's advertisements-credits to an external credit store, which may enable the user to use the credits in other shopping or e-shopping systems.

Content consumption modules 442 may be a standard or non-standard player, viewer, reader, word processor, or any other OS or other suitable program component which may make use of content (depending on the content's type), and enable the user to consume (read, view, run, listen to) the content.

Advertisements consumption modules 544 may be similar to the content consumption module, and may be any of the above.

Content consumption and payment driver 541 may interface with content consumption user interface 107 through external interface 115, and with the above modules 542, 543 and 544 through internal interfaces 551, 552 and 553 respectively. In addition or alternatively, driver 541 may interface with the personal storage advertising sub-system 104, which may provide it with advertisements per request. According to embodiments of the invention, driver 541 may interface with sub-system 104 over external interface 113. According to embodiments of the invention, driver 541 may get user input, including, for example, whether the user wishes to watch advertisements and accumulate advertisement credits, guidelines for advertisement selection (if relevant), whether the user wishes to pay for the content using advertisement credit, content selection (if relevant) and more. According to embodiments of the invention, driver 541 may get advertisement-credits from balance calculator 543, and/or retrieve content (if needed) and advertisements through external interfaces 114 and 113. According to embodiments of the invention, driver 541 may drive the content and advertisements consumption modules according to the advertisements-credit balance.

Two databases 546 and 545, which may contain advertisements and content tracking data respectively. Content 542 and advertisements 544 consumption modules may report back to driver 541, for example, when successful consumption ends. Driver 541 may store such information in the appropriate databases 544 or 545, and may further report back with a tracking message to the personal storage advertising sub-system 104.

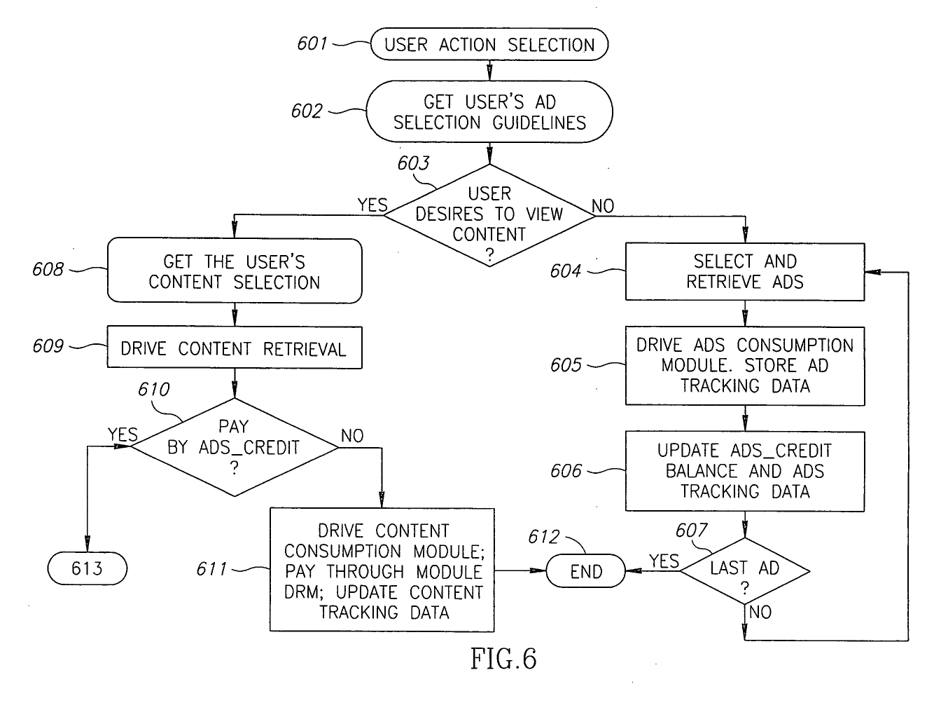

Reference is made to FIG. 6 showing an exemplary flow of a pay-by-add process according to embodiments of the invention. According to embodiments of the invention and as shown by block 601, the flow may include a user selection. According to embodiments of the invention, a user may select to consume content or advertisements. According to embodiments of the invention and as shown by block 602 the flow may further include acquiring a user selection, for example, a user may select to consume interactive advertisements, use bookmarking etc. According to embodiments of the invention and as shown by block 603 the flow may include determining whether the user selected to consume content or advertisements.

According to embodiments of the invention and as shown by block 604, if the user selected to consume advertisements the flow may include selecting and retrieving advertisements for consumption. According to embodiments of the invention, content consumption and payment driver 541 may perform a loop which may perform advertisements selection and retrieval through external interface 113. According to embodiments of the invention and as shown by block 605, the flow may include handing the received advertisements to the appropriate advertisements consumption module 544 which may play, display and/or execute the advertisements for the user. According to embodiments of the invention and as shown by block 606, the flow may include storing information, for example, with the advertisements tracking data module 546, and possibly calling the balance calculator 543 which may update the balance, according to the advertisements consumption return code. According to embodiments of the invention and as shown by block 607, the flow may include determining, possibly according to user supplied information, whether more advertisements are to be consumed by the user. According to embodiments of the invention, user supplied information may comprise, for example, consumption time and/or advertisements-credit value. According to embodiments of the invention and as shown by block 612, the flow may terminate, for example if no more advertisements are to be consumed.

According to embodiments of the invention and as shown by block 608, if the user selected to consume content the flow may include retrieving a user content selection. For example, driver 544 may use interface 115 to get a user content selection from content consumption user interface 107. According to embodiments of the invention and as shown by block 609 the flow may include retrieving content for consumption. For example, content retrieval module 106 may use external interface 114 in order to retrieve the required DRM protected content. According to embodiments of the invention, content to be consumed may originate from a content provider, and may further be DRM protected. DRM protection may be typically implemented by applying some cryptographic transformation lock by a secret keying material to the content. A DRM server may provide a license which unlocks the content, possibly after receiving proof from some third party that the user paid for the content.

According to embodiments of the invention and as shown by block 610, the flow may include determining a payment method, for example, whether the consumer wishes to pay for content consumption by viewing advertisements, or by some other method, for example, by credit card. According to embodiments of the invention, the role of determining payment method may be assumed by the content consumption and payment module 105.

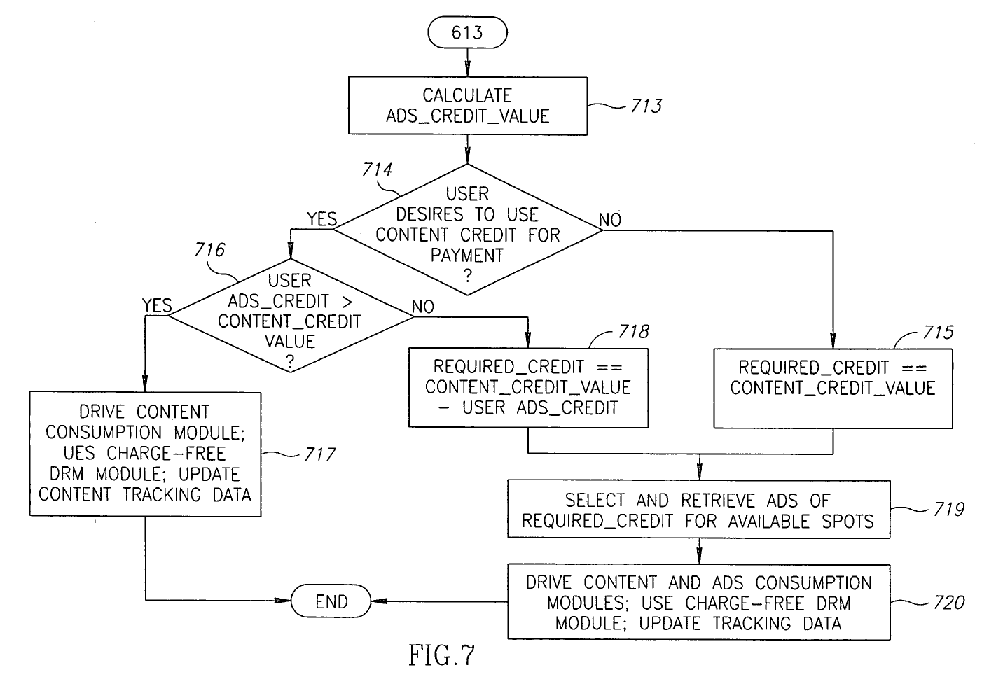

According to embodiments of the invention and as shown by block 613, the flow may include providing content for consumption, where payment for consumption may be performed by viewing advertisements. Payment for consumption of content by viewing advertisements will be described with reference to FIG. 7 below. Alternatively, if the consumer elects to pay for content consumption by methods other than advertisements viewing, the flow may include providing content as shown by 611. According to embodiments of the invention, content consumption module 542 may be provided with DRM protected content. The content consumption module, which may support various payment methods, and consumption models (e.g. pay-per-view, rent etc.), may unlock the DRM, and play/display/execute the content. After the content consumption module 542 returns, the content consumption and payment driver may update the content tracking data 545.

Reference is made to FIG. 7, which schematically illustrates an exemplary flow according to embodiments of the invention. According to embodiments of the invention, the flow depicted in FIG. 7 may be employed in order to support payment for content consumption by advertisements consumption.

According to embodiments of the invention and as shown by block 713 the flow may include calculating an advertisements credit value. Such value may indicate the amount of advertisements-credits to be charged for a consumption of the content in question. According to embodiments of the invention and as shown by block 714 the flow may include allowing a consumer to choose whether to pay for content consumption by advertisements-credits or by viewing advertisements. According to embodiments of the invention and as shown by block 715, if a consumer elects to pay for content consumption by viewing advertisements then a value of required credits may be calculated as shown by block 719. According to embodiments of the invention, content for consumption may be associated with advertisements-credits, namely, a price tag in the form of advertisements-credits may be associated with content. Accordingly, the number or volume of advertisements to be consumed may be calculated as shown by block 719 prior to presentation of content to a consumer.

According to embodiments of the invention and as shown by block 719 the flow may include retrieving advertisements for consumption. Such retrieval may be performed according to previously calculated advertisements volume. According to embodiments of the invention and as shown by block 720 content and advertisements may be presented to a consumer.

According to embodiments of the invention and as shown by block 714, a consumer of content may elect to pay for content consumption by using advertisements-credits. According to embodiments of the invention and as shown by block 716, the flow may include checking if the consumer may have enough advertisements-credits for paying for the desired content. For example, content calculator 543 may be called upon to execute such calculation. According to embodiments of the invention and as shown by block 717, if a consumer may have enough advertisements-credits to pay for the content in question then the content may be provided for consumption. For example, the content consumption and payment driver 541 may deliver content to the content consumption module 542 which may consume the content. Note that the content may be still be DRM protected. However, since in this case, the user may have already paid for the content by viewing advertisements in the past, the DRM server should not charge the user for the content. This charge free content consumption may be implemented by a dedicated DRM license request that the content consumption module 541 may send to a DRM server. Such request may contain a trusted attestation to the fact that the user may have indeed enough advertisements-credit generated either by the client itself (if it may be trusted) or by an external advertisements server. Upon getting this special license request and verifying the attestation the DRM server may deliver the required license without charging the user. Another option may be to have the content consumption and payment driver 541 request the license from the DRM server, and deliver it to the content consumption module 542 with the license. When content consumption ends, the driver may update the content tracking data 545.

According to embodiments of the invention and as shown by block 718, if the consumer doesn't have enough credit to pay for the content, the flow may include calculating the difference between required advertisements-credits and available advertisements-credits. According to embodiments of the invention, following a calculation of such difference the flow may include selecting and retrieving advertisements for consumption as shown by block 719 and further providing content and advertisements as shown by 720. For example, personal storage advertising sub-system 104, may provide a set of advertisements with the required advertisements-credits value for the available spots in the content. Accordingly, content and advertisements consumption modules 542 & 544 may handle the task of providing content and advertisements according to parameters such as, but not limited to, available spots in content and/or volume of advertisements required to be consumed.

According to embodiments of the invention, driver 541 may interchangeably drive content and advertisements consumption modules 542 & 544. Driver 541 may verify that the consumer actually consumes the advertisements (as oppose to, for example, skip them). According to embodiments of the invention, such verification may be accomplished by incrementing the advertisements-credit only when actual consumption happens. This way if an advertisement may be skipped, the driver may retrieve another advertisement instead. Advertisements skipping may be tracked the same way advertisements consumption are tracked. Tracking may further be fed into the user profiling module 205, which may assist the targeting. If the content consumption cannot be interrupted in the middle (e.g. content may be an executable), then the driver 541 may drive advertisements consumption (through the usage of the advertisements consumption module 544, up-to a required advertisements-credits value. According to embodiments of the invention, advertisements consumption may be enforced prior to delivering the content to the content consumption module 542. A DRM-protected content may be delivered to the content consumption module 542, and a charge-free DRM request may be sent to the DRM license server; accompanied by an attestation to the fact, that the user will consume enough advertisements to generate the required amount of advertisements-credit.

According to embodiments of the invention, if the spots are interleaved with content, and if further, advertisements and the content may be consumed by a single consumption module (e.g. a single player), then driver 541 may unlock the DRM protected content, create a single file, where the spots are filed with the appropriate advertisements, and send it to the content consumption module 542. During consumption, driver 541 may update the advertisements and the content consumption tracking data 546 & 545. Alternatively, for example, if content and advertisements cannot be provided by the same module (e.g. same player) then driver 541 may deliver the DRM-protected content to the content consumption module 542, which may unlock it using charge-free DRM license request. Driver 541 may pause content consumption module 542 when a spot may be encountered. At such point, an advertisement, possibly allocated to this spot by the personal storage advertising system 104, may be sent to the advertisements consumption module 542 in order to be provided to the consumer. The balance calculator 543, which may update the balance with the new value of the advertisement credit may be called either before or after the presentation of the advertisement to the consumer. In addition, the advertisements tracking data 546 may be updated prior to resuming an execution of the content consumption module. This process may continue per the user's choice until the amount of advertisements credit may be equal to the required content credit, or until all the available spots are used. When the process may be done, driver 541 may update content consumption tracking data 545.

The payment system described above may support traditional content consumption business models (e.g. pay-per-view, rent), and enhances the pay-by-ad model.

The “pay-by-ad” model may be considered to be a good fit for digital media charging. For example, in scenarios where the advertiser launches a campaign, and pays the CDN or the broadcasting platform owner, for a pre-determined number and pattern of advertisement viewing. The spots may be filled either on-the-fly (i.e. during the content consumption), or prepared prior to consumption. Either ways, the user may be fully or partially paying for the content by viewing the advertisements inserted into the spots. Literally speaking, the distribution/broadcasting platform owner may get paid for every advertisement the user views, and he may deduct this payment from the price of the content the user may be viewing.

According to the payment system described above, advertisement viewing may be a legitimate method of payment, like in the above models; however, it may be done independently of content consumption. For example, a user may elect to consume advertisements and get credit in return for such consumption, and the consumer may later consume content in exchange for credit such acquired. Such payment model may create a flexibility which may enable new methods for advertisement selection (e.g. interactive selection), which are described below in the local advertisement server section.

The new flexible pay-by-ad model requires new methods of advertisement handling, since the advertisement platform must be able to handle and play advertisement either in conjunction or separately from the content.

Since the content consumption and advertisement driver 541 may be used to drive both content and advertisements consumption from storage, it may be used to implement other novelties features in advertising.

One embodiment of the present invention may feature advertisement book-marking. According to this feature, the advertisement consumption module may be able to receive user inputs, and the user may bookmark an advertisement, requesting the system either to view the advertisement in the future, view a longer full version of it, or to go directly to an Internet website associated with the advertisement or the advertiser. If the advertisement may be queued for future viewing, then driver 541 may send the advertisement information to the personal storage advertising system, which may store it in the local advertisements store 204. If a longer version may be desired, then the driver 541 may send a request to the personal storage advertising sub-system 104 which may download the advertisement from the external advertisements server 102, and store it in the local advertisements store 204. When driver 541 identifies bookmark selection, it may access the personal storage advertising sub-system 104, which may retrieve the bookmarked advertisement. The driver then may send the advertisement to the advertisements consumption module 542. In case of bookmarking, the balance calculator may be updated only after the advertisement may have been consumed (and not after it had been bookmarked. Advertisements bookmarking may be valuable in case of interactive advertisements (described below).

Some embodiments of the invention may include advertisement selection, in which the personal storage advertising sub-system 104 may choose to deliver to driver 541 a set containing multiple advertisements choices. The user may choose the advertisements he wishes to consume. Selected advertisements may be consumed by the user as described above. The system may include a “variety” requirement that may prevent a user from consuming the same advertisement or a limited number of advertisements beyond a maximum threshold.

Some embodiments of the invention may include a promotion feature. A promotion “stand” may be a specific location, which may be sold to an advertiser, who may, in turn, use it for specific campaigns. The location may be hidden or transparent and opened by the user actively, for example, by clicking on a button in a specific location, in certain types of content, the content consumption module 542 may allocate a location (for example on screen), which will be used by advertisement consumption module 544 that may dynamically allocate set of advertisements selected and retrieved through the personal storage advertising sub-system 104. The advertisement selection module 206 may allocate to the promotion stand only advertisements that contain it as a location in their meta-data.

Some embodiments of the invention may include a feature of content play from advertisement, in which specific types of advertisements may contain pointers to full content items, which may, for example, be a standard hyperlink, or in itself a trailer (e.g., part of the content item). If the pointer may be selected by user input, the advertisement consumption module 544 may access driver 541, with a request for the full content item. Driver 541 may request items from the content retrieval module 206, and further support content consumption and payment as described in the above flow-chart.

Finally, some embodiments of the present invention may support transaction from advertisement, in which advertisement consumption module 544 may enable user interaction, and provide, for example, external transaction such as e-shopping, etc.

It may be to be understood that the invention may be not limited in its application to the details set forth in the description contained herein or illustrated in the drawings. The invention may be capable of other embodiments and of being practiced and carried out in various ways. It should be noted that the invention may be not bound by the specific algorithm of processing or specific structure. Those versed in the art will readily appreciate that the invention may be, likewise, applicable to any other processing or presentation with equivalent and/or modified functionality which may be consolidated or divided in another manner.

It will also be understood that the invention further contemplates a machine-readable memory tangibly embodying a program of instructions executable by the machine for executing the method of the invention.

Those skilled in the art will readily appreciate that various modifications and changes may be applied to the embodiments of the invention as hereinbefore described without departing from its scope, defined in and by the appended claims.

What is claimed is:

1. An apparatus for providing content and advertisements from storage, the apparatus comprising:
a download module to receive a plurality of digital advertisements;
a storage device, wherein said download module is configured to store said downloaded digital advertisements on said storage device;
an advertisement selection module configured to select based on an advertisement selection policy at least one of said plurality of stored advertisements for association with content stored on said apparatus;
a coordination module to coordinate providing said content with said selected advertisement; and
a display module to generate presentation of said coordinated content and selected advertisement to a presentation display associated with said apparatus.

2. The apparatus of claim 1, wherein said download module is further to receive said content, and wherein said storage device is further to store said content.

3. The apparatus of claim 1, further comprising a tracking module to record at least one advertising consumption parameter relating to consumption of said selected advertisement.

4. The apparatus of claim 3, wherein said tracking module is further to report said at least one advertisement consumption parameter to a remote advertisement tracking server.

5. The apparatus of claim 3, wherein said tracking module is further to update a credit database of advertising credits associated with said user based on said at least one recorded advertisement consumption parameter.

6. The apparatus of claim 3, further comprising an advertisement credit module to record advertisement credits based on said at least one advertising consumption parameter, and to report said advertising credits of said user to a remote advertising tracking server.

7. The apparatus of claim 6, wherein said advertisement credit module is further to convert recorded advertisement credits into at least one of cash, credit, products, services, premium content, and advertisement-free content consumption.

8. The apparatus of claim 1, wherein said download module is further to download said advertisement selection policy.

9. The apparatus of claim 1, wherein said advertisement selection policy comprises at least one selection parameter selected from the group consisting of: user-selected content, at least one keyword associated with user-selected content, a user consumption preference, a profile of said user, a consumption history of said user, a date on which said advertisement is presented, a time of day at which said advertisement is presented, and a geographic location of said apparatus.

10. The apparatus of claim 1, further comprising a bookmarking module to record a user indication of interest in an advertisement, and to retrieve material pertaining to said indicated advertisement.

11. The apparatus of claim 10, wherein said bookmarking module is to record said user indication of interest while content is being played, and wherein said apparatus is to retrieve said material pertaining to said indicated advertisement after consumption of said content is complete.

12. The apparatus of claim 1, further comprising a profiling module to obtain and locally store personal information associated with a user, and wherein said advertisement selection module is further configured to associate said advertisement with said stored content based at least on said personal information.

13. The apparatus of claim 12, wherein said personal information includes content consumption information relating to content presented to said user.

14. The apparatus of claim 1, further comprising a profiling module to obtain from a plurality of users user identifications and items of personal information, respectively, and to locally store said user identifications and items of personal information pertaining to each of said plurality of users, and wherein said advertisement selection module is further configured to associate said advertisement with said selected content based at least in part said items of personal information associated with the user consuming said selected content.

15. The apparatus of claim 1, wherein said coordination module is to coordinate providing said associated advertisement on a predefined region of said presentation display.

16. The apparatus of claim 1, further configured to invoke presentation of content associated with an advertisement presented to said user.

17. The apparatus of claim 1, further configured to invoke a transaction associated with an advertisement presented to said user.

18. The apparatus of claim 1, wherein said download module is further to download an advertisement pre-fetch policy and wherein said download module is further to download said plurality of advertisements based at least on said advertisement pre-fetch policy.

19. The apparatus of claim 1, further configured to track and record at least one content consumption parameter relating to consumption of said content.

20. The apparatus of claim 1, wherein said download module is to receive said plurality of digital advertisements from a remote server.

21. The apparatus of claim 1, further configured to modify at least one of said plurality of digital advertisements according to a parameter selected from the group consisting of: a user profile, a campaign, and a policy.

22. The apparatus of claim 1, further configured to modify said content according to a parameter selected from the group consisting of: a user profile, a campaign and a policy.

23. A method of providing advertisements from a local storage device, comprising:
downloading a plurality of digital advertisements;
storing said downloaded digital advertisements on a storage device associated with a user;
selecting at least one of said plurality of stored advertisements for association with content; and
providing said selected advertisements in coordination with said content.

24. The method of claim 23, wherein providing said selected advertisements comprises presenting said selected advertisements on an output device associated with said storage device.

25. The method of claim 23, further comprising recording at least one advertising consumption parameter relating to consumption of said advertisements associated with said content.

26. The method of claim 25, further comprising reporting said at least one advertisement consumption parameter to a remote advertisement tracking server.

27. The method of claim 25, further comprising updating a credit database of advertising credits associated with said user based on said at least one recorded advertisement consumption parameter.

28. The method of claim 25, further comprising recording advertisement credits based on said at least one advertising consumption parameter, and reporting said advertising credits of said user to a remote advertising tracking server.

29. The method of claim 28, further comprising converting recorded advertisement credits into at least one of cash, credit, products, services, premium content, and advertisement-free content consumption.

30. The method of claim 23, further comprising downloading an advertisement selection policy, and wherein selecting said advertisement comprises selecting at least one of said plurality of stored advertisements based at least on said advertisement selection policy.

31. The method of claim 23, wherein selecting said advertisement comprises selecting said advertisement based on at least one selection parameter selected from the group consisting of: user-selected content, at least one keyword associated with user-selected content, a user consumption preference, a consumption history of said user, a profile of said user, a viewing history of said user, a date on which said advertisement is presented, a time of day at which said advertisement is presented, and a geographic location of said apparatus.

32. The method of claim 23, further comprising downloading an advertisement campaign, and wherein selecting said at least one of said plurality of stored advertisements for association with content comprises selecting at least one of said plurality of stored advertisements for association with content based at least on said advertisement campaign.

33. The method of claim 23, further comprising recording a user indication of interest in an advertisement, and retrieving material pertaining to said indicated advertisement.

34. The method of claim 23, further comprising recording a user indication of interest in an advertisement while content is being played, and retrieving material pertaining to said indicated advertisement after consumption of said content is complete.

35. The method of claim 23, further comprising obtaining and locally storing personal information associated with said user, and wherein selecting said at least one of said plurality of stored advertisements comprises selecting said advertisement based at least on said personal information.

36. The method of claim 23, further comprising obtaining from a plurality of users user identifications and items of personal information, respectively, and locally storing said user identifications and items of personal information pertaining to each of said plurality of users, and wherein selecting said at least one of said plurality of stored advertisements comprises selecting said advertisement based at least in part said items of personal information associated with the user consuming said selected content.

37. The method of claim 23, further comprising modifying at least one of said plurality of digital advertisements according to a parameter selected from the group consisting of: a user profile, a campaign, and a policy.

38. The method of claim 23, further comprising modifying said content according to a parameter selected from the group consisting of: a user profile, a campaign, and a policy.

39. A computer readable medium having a set of instructions stored thereon that when executed by a processor of a computer cause the computer to:
download a plurality of digital advertisements;
store said downloaded digital advertisements on a storage device associated with a user;
select at least one of said plurality of stored advertisements for association with content; and
provide said selected advertisements in coordination with said content.

40. The computer readable medium of claim 39, wherein said set of instructions when executed cause said computer to provide said selected advertisements by presenting said selected advertisements on an output device associated with said storage device.

41. The computer readable medium of claim 39, wherein said set of instructions when executed further cause said computer to record at least one advertising consumption parameter relating to consumption of said advertisements associated with said content.

42. The computer readable medium of claim 41, wherein said set of instructions when executed further cause said computer to report said at least one advertisement consumption parameter to a remote advertisement tracking server.

43. The computer readable medium of claim 41, wherein said set of instructions when executed further cause said computer to update a credit database of advertising credits associated with said user based on said at least one recorded advertisement consumption parameter.

44. The computer readable medium of claim 41, wherein said set of instructions when executed further cause said computer to record advertisement credits based on said at least one advertising consumption parameter, and to report said advertising credits of said user to a remote advertising tracking server.

45. The computer readable medium of claim 44, wherein said set of instructions when executed further cause said computer to convert recorded advertisement credits into at least one of cash, credit, products, services, premium content, and advertisement-free content consumption.

46. The computer readable medium of claim 39, wherein said set of instructions when executed further cause said computer to download an advertisement selection policy, and wherein said set of instructions when executed cause said computer to select said advertisement by selecting at least one of said plurality of stored advertisements based at least on said advertisement selection policy.

47. The computer readable medium of claim 39, wherein said set of instructions when executed cause said computer to select said advertisement based on at least one selection parameter selected from the group consisting of: user-selected content, at least one keyword associated with user-selected content, a user consumption preference, a consumption history of said user, a profile of said user, a viewing history of said user, a date on which said advertisement is presented, a time of day at which said advertisement is presented, and a geographic location of said apparatus.

48. The computer readable medium of claim 39, wherein said set of instructions when executed further cause said computer to download an advertisement campaign, and wherein said set of instructions when executed cause said computer to select said at least one of said plurality of stored advertisements for association with content by selecting at least one of said plurality of stored advertisements for association with content based at least on said advertisement campaign.

49. The computer readable medium of claim 39, wherein said set of instructions when executed further cause said computer to record a user indication of interest in an advertisement, and to retrieve material pertaining to said indicated advertisement.

50. The computer readable medium of claim 39, wherein said set of instructions when executed further cause said computer to record a user indication of interest in an advertisement while content is being played, and to retrieve material pertaining to said indicated advertisement after consumption of said content is complete.

51. The computer readable medium of claim 39, wherein said set of instructions when executed further cause said computer to obtain and locally store personal information associated with said user, and wherein said set of instructions when executed cause said computer to select said at least one of said plurality of stored advertisements by selecting said advertisement based at least on said personal information.

52. The computer readable medium of claim 39, wherein said set of instructions when executed further cause said computer to obtain from a plurality of users user identifications and items of personal information, respectively, and to locally store said user identifications and items of personal information pertaining to each of said plurality of users, and wherein selecting said at least one of said plurality of stored advertisements comprises selecting said advertisement based at least in part said items of personal information associated with the user consuming said selected content.

53. The computer readable medium of claim 39, wherein said set of instructions when executed further cause said computer to modify at least one of said plurality of digital advertisements according to a parameter selected from the group consisting of: a user profile, a campaign, and a policy.

54. The computer readable medium of claim 39, wherein said set of instructions when executed further cause said computer to modify said content according to a parameter selected from the group consisting of: a user profile, a campaign, and a policy.

55. An apparatus for providing advertisements from storage, the apparatus comprising:
a download module to receive a plurality of digital advertisements from a remote server;
a storage device, wherein said download module is configured to store said downloaded digital advertisements on said storage device;
an advertisement selection module configured to select advertisements for consumption from said plurality of stored advertisements;
a coordination module to coordinate presentation of said selected advertisements; and
a tracking module to record at least one advertising consumption parameter relating to consumption of said selected advertisements.

56. The apparatus of claim 55, wherein said tracking module is further to report said at least one advertisement consumption parameter to a remote advertisement tracking server.

57. The apparatus of claim 55, wherein said tracking module is further to update a credit database of advertising credits associated with said user based on said at least one recorded advertisement consumption parameter.

58. The apparatus of claim 55, further comprising an advertisement credit module to record advertisement credits based on said at least one advertising consumption parameter, and to report said advertising credits of said user to a remote advertising tracking server.

59. The apparatus of claim 58, wherein said advertisement credit module is further to convert recorded advertisement credits into at least one of cash, credit, products, services, premium content, and advertisement-free content consumption.

60. The apparatus of claim 55, wherein said download module is further to download an advertisement selection policy, and wherein said advertisement selection module is further configured to select advertisements for consumption according to said selection policy.

61. The apparatus of claim 55, wherein said advertisement selection module is further adapted to select advertisements for consumption based on at least one selection parameter selected from the group consisting of: user-selected advertisements, at least one keyword associated with user-selected advertisements, a user consumption preference, a profile of said user, an advertisement consumption history of said user, a date on which said advertisement is presented, a time of day at which said advertisement is presented, and a geographic location of said apparatus.

62. The apparatus of claim 55, further comprising a bookmarking module to record a user indication of interest in an advertisement, and to retrieve material pertaining to said indicated advertisement.

63. The apparatus of claim 62, wherein said bookmarking module is to record said user indication of interest while advertisements are being provided, and wherein said apparatus is to retrieve said material pertaining to said indicated advertisement after consumption of said advertisements is complete.

64. The apparatus of claim 55, further comprising a profiling module to obtain and locally store personal information associated with a user, and wherein said advertisement selection module is further configured to associate said advertisement with content based at least on said personal information.

65. The apparatus of claim 55, further comprising a profiling module to obtain from a plurality of users user identifications and items of personal information, respectively, and to locally store said user identifications and items of personal information pertaining to each of said plurality of users, and wherein said advertisement selection module is further configured to select advertisements for consumption based, at least in part, on said items of personal information associated with the user consuming a selected advertisement.

66. The apparatus of claim 55, further configured to modify at least one of said plurality of digital advertisements according to a parameter selected from the group consisting of: a user profile, a campaign, and a policy.

67. A method of providing advertisements from a local storage device, comprising:
downloading a plurality of digital advertisements;
storing said downloaded digital advertisements on a storage device associated with a user;
selecting advertisements for consumption from said plurality of stored advertisements;
coordinating consumption of said selected advertisements;
presenting said selected advertisements according to said coordinating; and
recording at least one advertising consumption parameter relating to consumption of said advertisements.

68. The method of claim 67, wherein providing said selected advertisements comprises presenting said selected advertisements on an output device associated with said storage device.

69. The method of claim 67, further comprising reporting said at least one advertisement consumption parameter to a remote advertisement tracking server.

70. The method of claim 67, further comprising recording advertisement credits based on said at least one advertising consumption parameter.

71. The method of claim 70, further comprising reporting said advertising credits of said user to a remote advertising tracking server.

72. The method of claim 71, further comprising converting recorded advertisement credits into at least one of cash, credit, products, services, premium content, and advertisement-free content consumption.

73. The method of claim 67, further comprising downloading an advertisement selection policy, and wherein selecting at least some of said plurality of stored advertisements for consumption is based, at least in part, on said advertisement selection policy.

74. The method of claim 67, wherein selecting at least some of said plurality of stored advertisements for consumption is based on at least one selection parameter selected from the group consisting of: user-selected advertisements, at least one keyword associated with user-selected advertisements, a user consumption preference, an advertisement consumption history of said user, a profile of said user, a viewing history of said user, a date on which said advertisements are consumed, a time of day at which said advertisements are consumed, and a geographic location of said apparatus.

75. The method of claim 67, further comprising downloading an advertisement campaign, and wherein selecting at least some of said plurality of stored advertisements for consumption is based, at least in part, on said advertisement campaign.

76. The method of claim 67, further comprising recording a user indication of interest in an advertisement, and retrieving material pertaining to said indicated advertisement.

77. The method of claim 76, wherein recording said user indication of interest comprises recording said user indication of interest while advertisements are being consumed, and retrieving material comprises retrieving said material pertaining to said indicated advertisement after consumption of said advertisements is complete.

78. The method of claim 67, further comprising obtaining and locally storing personal information associated with said user, and wherein selecting at least some of said plurality of stored advertisements for consumption is further according to said personal information.

79. The method of claim 67, further comprising obtaining from a plurality of users user identifications and items of personal information, respectively, and locally storing said user identifications and items of personal information pertaining to each of said plurality of users, and wherein selecting at least some of said plurality of stored advertisements for consumption is based, at least in part, on said items of personal information associated with the user consuming advertisements.

80. The method of claim 67, further comprising modifying at least some of said plurality of digital advertisements according to a parameter selected from the group consisting of: a user profile, a campaign, and a policy.

81. A computer readable medium having a set of instructions stored thereon that when executed by a processor of a computer cause the computer to:
download a plurality of digital advertisements;
store said downloaded digital advertisements on a storage device associated with a user;
select advertisements for consumption from said plurality of stored advertisements;
coordinate consumption of said selected advertisements;
present said selected advertisements according to said coordinating; and
record at least one advertising consumption parameter relating to consumption of said advertisements.

82. The computer readable medium of claim 81, wherein said set of instructions when executed cause said computer to provide said selected advertisements by presenting said selected advertisements on an output device associated with said storage device.

83. The computer readable medium of claim 81, wherein said set of instructions when executed further cause said computer to report said at least one advertisement consumption parameter to a remote advertisement tracking server.

84. The computer readable medium of claim 81, wherein said set of instructions when executed further cause said computer to record advertisement credits based on said at least one advertising consumption parameter.

85. The computer readable medium of claim 84, wherein said set of instructions when executed further cause said computer to report said advertising credits of said user to a remote advertising tracking server.

86. The computer readable medium of claim 85, wherein said set of instructions when executed further cause said computer to convert recorded advertisement credits into at least one of cash, credit, products, services, premium content, and advertisement-free content consumption.

87. The computer readable medium of claim 81, wherein said set of instructions when executed further cause said computer to download an advertisement selection policy, and wherein said set of instructions when executed further cause said computer to select at least some of said plurality of stored advertisements for consumption based, at least in part, on said advertisement selection policy.

88. The computer readable medium of claim 81, wherein said set of instructions when executed cause said computer to select at least some of said plurality of stored advertisements for consumption based on at least one selection parameter selected from the group consisting of: user-selected advertisements, at least one keyword associated with user-selected advertisements, a user consumption preference, an advertisement consumption history of said user, a profile of said user, a viewing history of said user, a date on which said advertisements are consumed, a time of day at which said advertisements are consumed, and a geographic location of said apparatus.

89. The computer readable medium of claim 81, wherein said set of instructions when executed further cause said computer to download an advertisement campaign, and wherein said set of instructions when executed cause said computer to select at least some of said plurality of stored advertisements for is based, at least in part, on said advertisement campaign.

90. The computer readable medium of claim 81, wherein said set of instructions when executed further cause said computer to record a user indication of interest in an advertisement, and to retrieve material pertaining to said indicated advertisement.

91. The computer readable medium of claim 90, wherein said set of instructions when executed cause said computer to record said user indication of interest by recording said user indication of interest while advertisements are being consumed, and wherein said set of instructions when executed cause said computer to retrieve material by retrieving said material pertaining to said indicated advertisement after consumption of said advertisements is complete.

92. The computer readable medium of claim 81, wherein said set of instructions when executed further cause said computer to obtain and locally store personal information associated with said user, and wherein said set of instructions when executed further cause said computer to select at least some of said plurality of stored advertisements for consumption further according to said personal information.

93. The computer readable medium of claim 81, wherein said set of instructions when executed further cause said computer to obtain from a plurality of users user identifications and items of personal information, respectively, and to locally store said user identifications and items of personal information pertaining to each of said plurality of users, and wherein said set of instructions when executed cause said computer to select at least some of said plurality of stored advertisements for consumption based, at least in part, on said items of personal information associated with the user consuming advertisements.

94. The computer readable medium of claim 81, wherein said set of instructions when executed further cause said computer to modify at least some of said plurality of digital advertisements according to a parameter selected from the group consisting of: a user profile, a campaign, and a policy.
